(19) United States
(12) Patent Application Publication
(10) Pub. No.: US 2015/0269612 A1
(43) Pub. Date: Sep. 24, 2015

(54) ENTITY PLATFORM AND ENTITY STORE

(71) Applicant: Microsoft Corporation, Redmond, WA (US)

(72) Inventor: Silviu-Petru Cucerzan, Seattle, WA (US)

(73) Assignee: Microsoft Corporation, Redmond, WA (US)

(21) Appl. No.: 14/218,678

(22) Filed: Mar. 18, 2014

(51) Int. Cl. G06Q 30/02

(52) U.S. Cl. CPC G06Q 30/0251

(57) ABSTRACT

A “Document Enhancer” provides an entity platform that ingests entity collections, information sources, topical databases, etc., and generates corresponding knowledge bases (KB's) and entity extraction services. This platform enables various user authorization scenarios for obtaining access to one or more KB's. Further, this platform processes arbitrary user content, e.g., documents, images, text fragments, speech, etc., to determine which KB's are relevant to that content. If access to relevant KB's is authorized, the Document Enhancer employs those KB's to analyze and augment the arbitrary content. Content augmentation examples include adding hyperlinks, highlighting relevant information, inserting relevant information into popups, windows, or tabs, enabling searches and services based on selected KB's, etc. An entity store maintains a library of available KB's that may be accessed by the user. Local or remote access to relevant KB's is obtained through various means, including, but not limited to, subscriptions, ad-supported access, free access, etc.

### BACKGROUND

Users often desire additional information with respect to concepts and entities that are mentioned in documents or other content that they are creating, processing, reading, etc. For example, a user that is reading a “Harry Potter” book may want to obtain additional information about one of the characters mentioned in the text she is reading. Similarly, a physician reading a medical journal paper may want to obtain additional information about a condition mentioned in that paper. Correspondently, a patient may want to obtain basic information about a condition mentioned by her physician.

Unfortunately, general Web or site searches for a word or set of words of interest (e.g., search queries) are prone to numerous retrieval errors due to the various types of ambiguity in natural language (e.g., metonymy, synonymy, lexical choice, etc.). However, in many cases, users can search existing vertical search engines or domain-specific collections of entities (such as characters in a series of books, particular diseases, sports statistics, etc.) that were created or aggregated by various content providers (e.g., various “Wiki” type collections, informational websites such as WedMD.com or FoxSports.com, etc.) that can be searched by the user to obtain additional information for particular topics or entities of interest. Unfortunately, the user must typically be aware of such resources and make manual determinations of which resources are relevant should be accessed to obtain the additional information desired.

Further, various conventional techniques exist that analyze user documents, user queries, fragments of text, etc., and then extract and disambiguate the concepts and entities within that content. The resulting concepts and entities are then used to access relevant information about them in various targeted knowledge bases. Unfortunately, users are often unaware of, or do not have access to, particular knowledge bases that could be used to obtain additional relevant information that they may be seeking. Moreover, some of these resources may not be available for Web search engines to index. Further, users with access to multiple knowledge bases typically have to search each of these resources individually to access relevant information in such sources.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Further, while certain disadvantages of prior technologies may be noted or discussed herein, the claimed subject matter is not intended to be limited to implementations that may solve or address any or all of the disadvantages of those prior technologies.

In general, a “Document Enhancer,” as described herein, provides various techniques for semantically evaluating arbitrary user content to select or recommend one or more relevant expert knowledge bases (KB's). The Document Enhancer then provides various mechanisms that allow the user to obtain access to one or more of the selected or recommended expert KB's. Finally, the Document Enhancer uses one or more the expert KB's for which the user has obtained access to evaluate and augment the arbitrary user content. Note that in various embodiments, the Document Enhancer either constructs a library of expert KB's from corresponding collections of entities, information sources, topical databases, etc., or receives one or more expert KB's from various sources.

More specifically, the Document Enhancer begins operation by performing an initial analysis of arbitrary user content, e.g., documents, images, queries, text fragments, speech, etc., to extract or identify “entities” in that arbitrary content. Note that such entities include, but are not limited to, names, places, topical phrases or terms, dates, general or specific concepts or subjects, etc. Note also that a large variety of conventional techniques for extraction and disambiguation of entities from various types of content are well known to those skilled in the art and will not be described in detail herein.

Once the Document Enhancer has extracted or identified entities in the arbitrary content, the Document Enhancer then identifies one or more relevant expert KB's from the library of expert KB's. Note that this library of expert KB's is also referred to herein as an “entity collection” or the like. Relevancy of particular expert KB's to the entities in the arbitrary content is generally determined by statistically or probabilistically matching those entities to semantic topics or entities of one or more of the expert KB's. Further, it should be understood that in various embodiments, the Document Enhancer employs information aggregated from the various KB's to identify the entities in the arbitrary content. As such, the Document Enhancer can use the information from various KB's to determine each entities would be triggered by which KB for use in returning relevant information to the user.

Following identification of one or more relevant expert KB's, the Document Enhancer determines whether the user has obtained or been granted access to some or all of the identified expert KB's. If the user has acquired access to any of the relevant expert KB's, the Document Enhancer then employs those expert KB's to perform an optional secondary analysis of the arbitrary content for extracting and disambiguating entities in that content. In other words, in various embodiments, the Document Enhancer performs secondary entity extraction services that are automatically tailored or customized to particular expert KB's. As such, the entities resulting from this secondary extraction and identification process may differ, at least in part, from the initially identified entities. In one embodiment, access to one or more of the identified relevant KB's is provided via an entity store or the like (e.g., an “app store” such as, for example, the online Microsoft® Windows® Store) that maintains a library of expert KB's. Local or remote access or licenses for one or more of the relevant KB's is obtained from the entity store through various means, including, but not limited to, paid temporary or permanent access, subscription based access, ad-supported access, free access, etc.

Whether or not a secondary analysis for extracting and identifying entities in the arbitrary content is performed, the Document Enhancer then employs the expert KB's for which the user has been granted access to augment that arbitrary content. In general, this augmentation includes, but is not limited to, using those expert KB's to add hyperlinks to entities within the arbitrary content, highlighting relevant entities in the arbitrary content, adding information or content from the expert KB's into (or adjacent to) the arbitrary content, initiating entity-based searches using the selected KB's, etc.

Note that construction of the expert KB's is achieved through various means. For example, in various embodiments, from various private or public sources, the Document Enhancer receives or ingests a plurality of topical databases or information collections in a plurality of formats (e.g., existing Wikia collections) and processes the databases and information to construct corresponding expert KB's. Alternately, or in combination, the Document Enhancer receives one or more existing expert KB's from third parties. In various embodiments, the Document Enhancer also optionally receives and/or customizes various contexts and entities on a per-user basis to create customized KB's for one or more users.

In view of the above summary, it is clear that the Document Enhancer described herein provides various techniques for evaluating arbitrary user content to select one or more relevant expert KB's. The Document Enhancer then provides various mechanisms that allow the user to obtain access to one or more of the selected expert KB's, which are then used to evaluate and augment the arbitrary user content. In addition to the just described benefits, other advantages of the Document Enhancer will become apparent from the detailed description that follows hereinafter when taken in conjunction with the accompanying drawing figures.

### BRIEF DESCRIPTION OF THE DRAWINGS

The specific features, aspects, and advantages of the claimed subject matter will become better understood with regard to the following description, appended claims, and accompanying drawings where:

FIG. 1 provides an exemplary high-level overview of a “Document Enhancer” that evaluates arbitrary user content to select one or more relevant expert knowledge bases, provides access to one or more of those knowledge bases, and then uses those knowledge bases to evaluate and augment the arbitrary content, as described herein.

FIG. 2 provides an illustration of an interface to various types of expert knowledge bases and corresponding entity extraction services for use in analyzing and augmenting arbitrary user content, as described herein.

FIG. 3 provides an exemplary architectural flow diagram that illustrates program modules for implementing various embodiments of the Document Enhancer, as described herein.

FIG. 4 provides a general system flow diagram that illustrates exemplary methods for implementing various embodiments of the Document Enhancer, as described herein.

FIG. 5 is a general system diagram depicting a simplified general-purpose computing device having simplified computing and I/O capabilities for use in implementing various embodiments of the Document Enhancer, as described herein.

### DETAILED DESCRIPTION OF THE EMBODIMENTS

In the following description of the embodiments of the claimed subject matter, reference is made to the accompanying drawings, which form a part hereof, and in which is shown by way of illustration specific embodiments in which the claimed subject matter may be practiced. It should be understood that other embodiments may be utilized and structural changes may be made without departing from the scope of the presently claimed subject matter.

### 1.0 Introduction

In general, a “Document Enhancer,” as described herein, provides various techniques for semantically evaluating arbitrary user content to select or recommend one or more relevant expert knowledge bases (KB's). The Document Enhancer then provides various mechanisms that allow the user to obtain access to one or more of the selected or recommended expert KB's. Finally, the Document Enhancer uses one or more the expert KB's for which the user has obtained access to evaluate and augment the arbitrary user content.

Note that the term “content” as described herein includes, but is not limited, to recognized speech, documents such as text, incoming or outgoing emails, images, etc. In other words, content being consumed by the user includes any text, any speech, images, or any other content, controls, buttons, links, etc., in any document being viewed or otherwise consumed by the user.

The Document Enhancer employs knowledge bases derived from domain-dependent entity collections from various data providers, in addition to various large general knowledge bases (such as derived from “Wikipedia” or similar collections). The Document Enhancer then provides expert KB-based domain-specific text/speech analysis services to client applications for arbitrary user content being processed or viewed by those client applications. In various embodiments, these services, and the corresponding expert KB's, are advertised through an entity store (e.g., an app store or the like), from which users can acquire licenses or permissions that allow client applications to use one or more of the expert KB's. The expert KB's can also be advertised/suggested upon the analysis of a document accessed by the user.

Third-party content providers, e.g., WebMD® or any other site having specialized or expert information collections, can provide some or all of their content in an expert KB format suitable for use with the Document Enhancer. Alternately, some or all of the content of any third party provider can be processed by an entity ingestion interface component of the Document Enhancer that ingests and processes various topical databases or information collections to construct corresponding expert KB's or entity collections.

For example, in the case of a collection of data content or informational entities related to the medical field such as, for example, WebMD®, such collections are transformed or formatted by the Document Enhancer into a medical knowledge base to be employed by a medical-domain entity service of the Document Enhancer. Such services, and the corresponding expert KB, is then licensed or otherwise authorized through the entity store. A user that obtains a license for the corresponding service or expert KB can, for example, employ it in a document reader when browsing, reading, or creating documents, such as articles, emails, messages, etc., in the medical domain to get automated pointers to relevant content from that service or expert KB for any entities in those articles.

For example, an email message sent to a user by a doctor regarding the user's medical condition can be automatically augmented with additional relevant information for the user by the Document Enhancer, either when the doctor composes the message (in which case the doctor may want to use one of the medical KBs that the patient can access) or when the user opens the email message to read it. In other words, the Document Enhancer evaluates the content that the user is browsing, reading, or creating and automatically enhances that content as described herein. Note also that the Document Enhancer may use multiple licensed or authorized services and expert KB's to enhance content being consumed or created by the user.

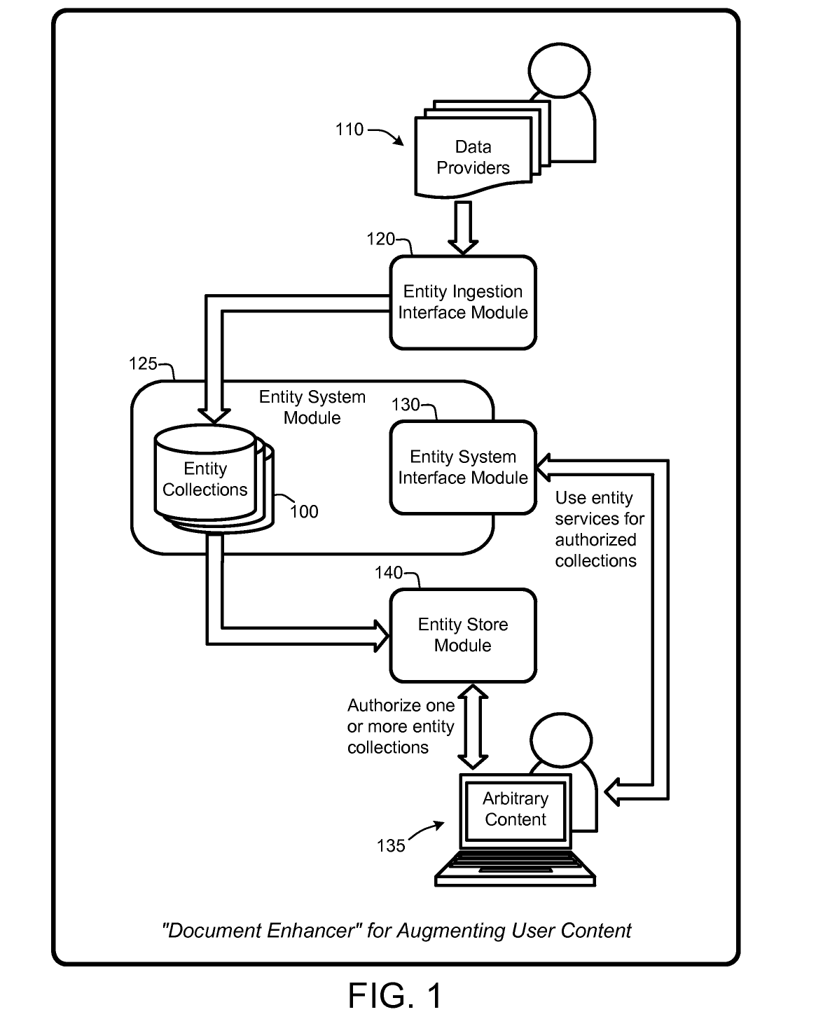

FIG. 1, as described below, provides an exemplary high-level overview of the techniques summarized above. Note that FIG. 1 is not intended to provide an exhaustive or complete illustration of every possible embodiment of the Document Enhancer as described throughout this document, and that FIG. 1 is intended only as an introduction to detailed description of the Document Enhancer that follows.

As illustrated by FIG. 1, the Document Enhancer constructs or receives one or more expert KB's (also referred to as “entity collections” 100) from one or more data providers 110 via an entity ingestion interface module 120. More specifically, the entity ingestion interface module 120 ingests a plurality of topical databases or information collections in any of a plurality of formats and processes the databases and information to construct corresponding expert KB's or entity collections 110.

An entity system module 125 then aggregates these entity collections 100 and generates corresponding entity extraction services for each entity collection or expert KB. Note that these entity extraction services are used by various embodiments of the Document Enhancer to analyze content being consumed or created by the user so that such content can be augmented relative to corresponding relevant expert KB's as discussed herein. An entity system interface module 130 then acts as an interface that enables the entity system module 125 to apply the entity collections 100 and corresponding entity extraction services to arbitrary content 135 of one or more users. In general, the entity system module 125 determines which entity collections 100 or expert KB's are relevant to the arbitrary content. Then, if the user is authorized (via an entity store module 140) to access those entity collections 100 or expert KB's, the entity system module 125 employs one or more of those entity collections or expert KB's to analyze and augment the arbitrary content.

As discussed in further detail herein, the entity store module 140 enables the user to acquire licenses or permissions for one or more of the entity collections 100 or expert KB's. In various embodiments, these licenses or permissions are acquired either via manual user selection or in response to recommendations of relevant entity collections 100 or expert KB's provided by the entity system interface module 130. Note that such recommendations are based on a determination of relevancy between entities or information extracted from the arbitrary content 135 and one or more of the entity collections 100 or expert KB's. Alternately, such licenses or permissions can be acquired by the user at any time for any of the entity collections 100 or expert KB's via the entity store module 140.

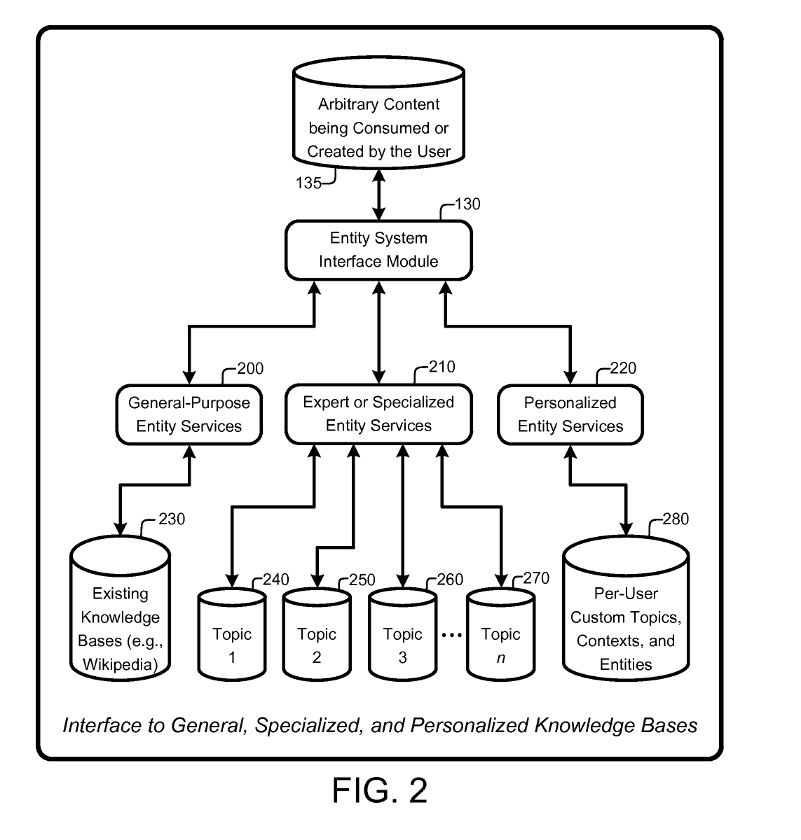

FIG. 2 shows an illustration of various interfaces to different types or categories of expert KB's and corresponding entity extraction and augmentation services provided by the aforementioned entity system interface module 130. In general, the Document Enhancer considers three basic categories for entity extraction and augmentation services, via the aforementioned entity system interface module 130 relative to the arbitrary content 135 being consumed or created by the user. These entity extraction and augmentation services include, but are not limited to general-purpose entity services 200, expert or specialized entity services 210 and personalized entity services 220.

As noted above, when requested by a client application (e.g., text editor, browser, etc.), the Document Enhancer analyzes the arbitrary content 135 using one or more of the general-purpose entity services 200, the expert or specialized entity services 210 and the personalized entity services 220 and any corresponding relevant KB's for which the user has obtained authorized access to identify one or more KB's that are relevant to the arbitrary content of the user.

Each entity service accesses one or more KB's and include entity extraction services that are trained on each of the KB's that they access to provide KB-specific extraction services. For example, the general-purpose entity services 200 operate using various public or existing KB's 230 (e.g., Wikipedia, for example). The expert or specialized entity services 210 operate using a variety of expert KB's relating to various topics (e.g., “Topic 1” 240, “Topic 2” 250, “Topic 3” 260, “Topic n” 270, etc.). The personalized entity services 220 operate using one or more custom KB's 280 that include custom topics, contexts and entities that are created, customized, and/or maintained on a per-user basis, as well as any expert KB's for which the user has previously obtained access. In addition to analyzing the arbitrary content of the user, these entity services also use one or more of the KB's to which the user has access to augment that content.

Note also that the user can explicitly inform any client application that interacts with the entity system interface module 130 of the Document Enhancer what domain, entity collection, or expert KB should be used or targeted for content analysis and augmentation. For example, if the user reads a Harry Potter book, then the user can direct the Document Enhancer to perform analysis of any fragment of text from that book using particular entity collections, such as a Harry Potter knowledge base derived from sources such as, for example, the existing Wikia collection available at http://harrypotter.wikia.com.

With respect to the aforementioned per-user custom topics, contexts and entities provided by the personalized entity services 220 that operate using one or more custom KB's 280, the Document Enhancer provides users with the capability to personalize the aforementioned content analysis process by storing and using historical information about one or more entity collections or expert KB's previously targeted by the documents or other content accessed by the user.

### 1.1 System Overview

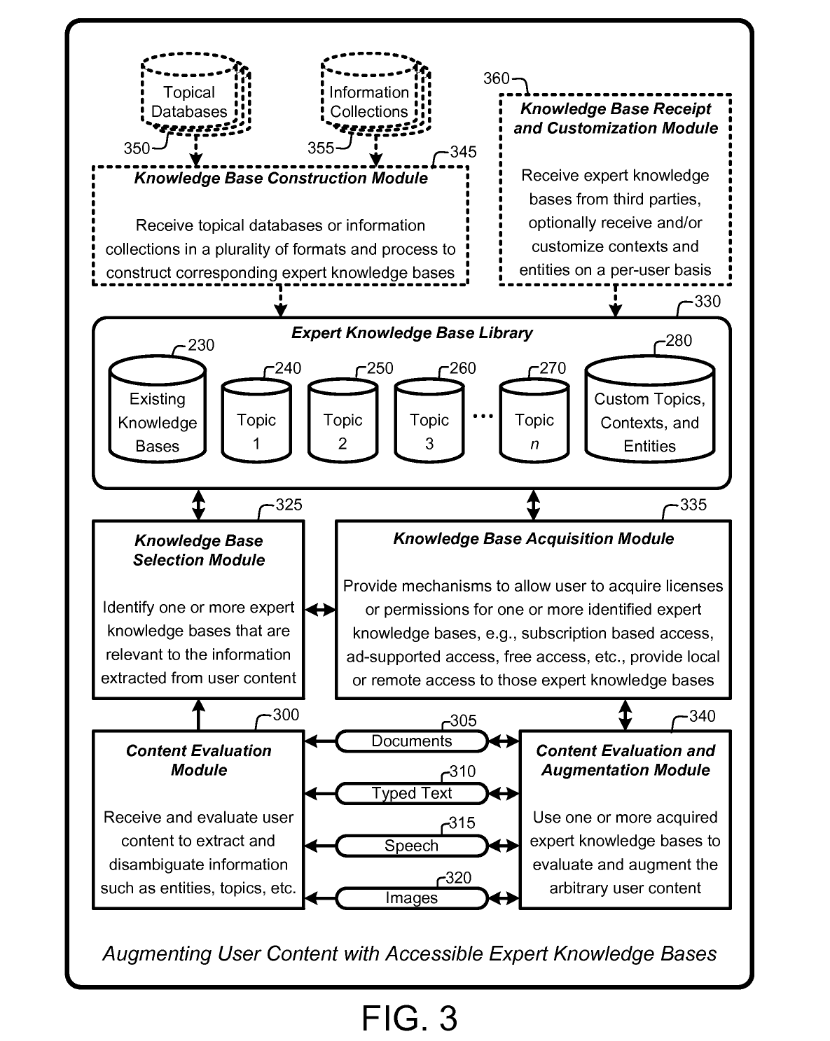

As noted above, the Document Enhancer provides various techniques for semantically evaluating arbitrary user content to select or recommend one or more relevant expert knowledge bases (KB's). The Document Enhancer then provides various mechanisms that allow the user to obtain access to one or more of the selected or recommended expert KB's. Finally, the Document Enhancer uses one or more the expert KB's for which the user has obtained access to evaluate and augment the arbitrary user content. The processes summarized above are illustrated by the general system diagram of FIG. 3. In particular, the system diagram of FIG. 3 illustrates the interrelationships between program modules for implementing various embodiments of the Document Enhancer, as described herein. Furthermore, while the system diagram of FIG. 3 illustrates a high-level view of various embodiments of the Document Enhancer, FIG. 3 is not intended to provide an exhaustive or complete illustration of every possible embodiment of the Document Enhancer as described throughout this document.

In addition, it should be noted that any boxes and interconnections between boxes that may be represented by broken or dashed lines in FIG. 3 represent various alternate embodiments of the Document Enhancer described herein, and that any or all of these alternate embodiments, as described below, may be used in combination with other alternate embodiments that are described throughout this document.

In general, as illustrated by FIG. 3, the processes enabled by the Document Enhancer begin operation by using a content evaluation module 300 to receive and evaluate arbitrary user content (e.g., documents 305, typed text 310, speech 315, images 320, etc.) to extract and disambiguate information such as entities, topics, etc., from that content. Note also that a secondary entity extraction and disambiguation process can be performed on the user content by the Document Enhancer after the user has obtained access to one or more recommended expert KB's.

A knowledge base selection module 325 identifies and recommends one or more expert KB's from an expert knowledge base library 330 that are relevant to the information extracted from the arbitrary user content. Note that as discussed in further detail in Section 2.3 of this document, the knowledge base selection module 325 matches the semantic, lexical, or image-based context of various entities and information extracted from content being consumed or created by the user to one or more relevant expert KB's. These matching expert KB's contain additional relevant information related to one or more of the entities extracted from the users content. Note that relevant expert KB's may be based on topics associated with extracted entities rather than the individual entities themselves. For example, in various embodiments, the Document Enhancer determines a topic in the KB based on the entities extracted from the user's content and provides additional content related to the topic rather than just to individual entities. Augmentation of the content relative to such topics can then be provided as a set of links to those topics inserted into the content, as informational popups or overlays added to the content, as information or links provided in adjacent windows or tabs, etc.

A knowledge base acquisition module 335 then provide various mechanisms to allow user to acquire licenses or permissions for one or more of the recommended expert KB's, e.g., subscription based access, ad-supported access, free access, etc., and then provides local or remote access to those expert knowledge bases for use in the entity extraction and content augmentation services described herein.

As noted above, in various embodiments, the Document Enhancer receives or constructs the various KB's used to populate the expert knowledge base library 330. For example, in various embodiments, a knowledge base construction module 345 receives one or more topical databases 350 or information collections 355 in a plurality of formats and processes those databases and information to construct corresponding expert knowledge bases for use in the expert knowledge base library 330. In addition, in various embodiments, a knowledge base receipt and customization module 360 is used to receive one or more expert knowledge bases from third parties, and to optionally receive and/or customize various contexts and entities on a per-user basis, as discussed above.

### 2.0 Operational Details of the Document Enhancer

The above-described program modules are employed for implementing various embodiments of the Document Enhancer. As summarized above, the Document Enhancer provides various techniques for evaluating arbitrary user content to select one or more relevant expert KB's. The Document Enhancer then provides various mechanisms that allow the user to obtain access to one or more of the selected expert KB's, which are then used to evaluate and augment the arbitrary user content. The following sections provide a detailed discussion of the operation of various embodiments of the Document Enhancer, and of exemplary methods for implementing the program modules described in Section 1 with respect to FIG. 1 through FIG. 3. In particular, the following sections provides examples and operational details of various embodiments of the Document Enhancer, including:

An operational overview of the Document Enhancer;

Evaluating user content to perform entity extraction and disambiguation;

Matching user content to one or more expert KB's;

Authorization for use of KB's;

Augmentation of user content; and

Exemplary system architecture options.

### 2.1 Operational Overview

As noted above, the Document Enhancer-based processes described herein provide various techniques for evaluating arbitrary user content to select one or more relevant expert KB's. The Document Enhancer then provides user access to one or more of the selected expert KB's, which are then used to evaluate and augment the arbitrary user content. In other words, in the broadest sense, the Document Enhancer performs a preliminary text matching analysis, content analysis, or semantic analysis to identify or extract concepts, entities or topics in the content being consumed by the user. The Document Enhancer then uses that preliminary semantic analysis to identify one or more expert or specialized KB's. If the user is authorized to use the identified KB's, those KB's are used to augment the user content as described herein. In further optional embodiments, if the user subsequently obtains authorization to use any of those identified KB's, the Document Enhancer uses those KB's to perform an optional secondary semantic analysis of the user's content and to augment that content as described herein. For example, consider the case where the Document Enhancer analyzes arbitrary user content, and then identifies one or more relevant KB's. Then, assuming that that the user subsequently obtains a license or other access rights to a recommended KB that wasn't available when the initial analysis was performed, the Document Enhancer can use the newly licensed or accessible KB to perform a more directed semantic analysis of the user content.

The above-summarized capabilities provide a number of advantages, including, but not limited to, the advantages summarized below. For example, the Document Enhancer provides a platform that allows the user to select or otherwise obtain access to a wide range of topic-based expert KB's that are likely to be relevant to various content being consumed or created by the user. The Document Enhancer then improves user experience by using those expert KB's to analyze and augment that user content with information, links, images, and other data that is relevant to the particular content being consumed or created by the user.

### 2.2 Entity Extraction and Disambiguation from User Content

As is well known to those skilled in the art, there is a wide range of existing entity extraction techniques for processing or evaluating documents or other content to identify or extract named entities (e.g., names, places, etc.), topical phrases or terms, dates, etc. Entity extraction systems typically use a variety of computational techniques to identify or extract instances of entities, phrases, dates, etc., in text or other content. Such identification and extraction may include all instances of entities, phrases, dates, etc., or may limit the identification and extraction to relevant instances of this information. Such techniques are well known to those skilled in the art, and will not be described in detail herein.

However, when mentions of entities such as names, places, dates, etc., are extracted from documents or other user content, it is not always clear what entity corresponds to the extracted mention. For example, the term “Columbia” can be mentioned in the same or different documents with the intent to refer to different named entities (e.g., space shuttle missions, the space shuttle accident, the university in New York, the river, the country—a common misspelling—, the sports clothing company, etc.). Fortunately, various conventional disambiguation techniques can be used to resolve conflicts that arise when a single term or concept is ambiguous in the sense that the term could relate to more than one topic or subject. The disambiguation process typically evaluates the context in which such terms are presented in the document or other content to identify the most likely or intended meaning of the term. For example, U.S. Pat. No. 8,112,402, by Cucerzan, et al., issued Feb. 7, 2012, and entitled “Automatic Disambiguation Based on a Reference Resource,” describes a variety of disambiguation techniques that may be adapted for use by the Document Enhancer.

In general, the Document Enhancer performs an initial entity extraction from the arbitrary content being consumed by the user using various matching techniques that may be augmented with contextual or semantic analyses that employ various disambiguation techniques. Such entity extraction and disambiguation is performed at various levels relative to the user content. For example, entity extraction and disambiguation can be performed across the entire document or content as a whole. Similarly, entity extraction and disambiguation can be performed on a paragraph-by-paragraph basis throughout the user content. In addition, finer granularity can be achieved by performing entity extraction and disambiguation on a sentence by sentence or even word-by-word basis in same paragraph or sentence (e.g., one paragraph may discuss the use of the word “Columbia” as a country (though the correct spelling of the country name is “Colombia”), as a name of a space shuttle, as a sports clothing company, as “Columbia Records,” etc.

Note that each instance of a particular term such as “Columbia” may map to a different expert KB, even within the same paragraph or sentence. For example, the text fragment “. . . the band was signed to Columbia Records while mountain climbing in Columbia to promote Columbia sportswear . . . ” includes three distinct and unrelated references to the term “Columbia” (with the country of “Colombia” being spelled incorrectly in this example, but being correctly disambiguated by the Document Enhancer). The general idea is to use existing semantic analysis and disambiguation techniques to identify the correct entities, and the correct semantic context of those entities, in the user content.

Note that following the identification of one or more matching or relevant expert KB's (as discussed below in Section 2.3), the Document Enhancer employs one or more expert KB's for which the user has obtained authorization or access to evaluate and augment the user content, typically in conjunction with one or more general knowledge bases such as one derived from Wikipedia or other information sources. For example, in the case of a semantic analysis of the user content, the semantic analysis can employ any combination of one or more expert KB's by themselves, one or more expert KB's in addition to a general KB such as derived from Wikipedia or other information source, or a general KB only if no expert KB was identified as sufficiently matching the arbitrary content. A simple example of a case where no expert KB may sufficiently match arbitrary content is content in the local news, for which Wikipedia, or other general information source, has a few relevant entities but for which there is no expert KB that matches the content or topics related to that content. In such cases, the Document Enhancer falls back to the general KB to augment the content with whatever relevant information is available.

Optionally, as noted above, where authorization to access one or more expert KB's is not obtained until after the initial extraction of entities from the user content, the Document Enhancer may perform an optional secondary analysis of the arbitrary content for extracting and identifying entities in that content prior to content augmentation. In other words, in various embodiments, the Document Enhancer performs secondary entity extraction services that are automatically tailored or customized to particular expert KB's. As such, the entities resulting from this secondary extraction and identification process may differ, at least in part, from the initially identified entities. Note that this secondary entity extraction can also be used as the basis to perform additional rounds of matching to one or more additional expert KB's. In any case, the entities resulting from this secondary extraction and identification process are also used as the basis for augmenting the corresponding user content.

### 2.3 Matching User Content to Knowledge-Bases

In general, once the semantic, lexical, or image-based context of various entities extracted from content being consumed by the user has been determined, the Document Enhancer can then match that context to one or more relevant expert KB's. These matching expert KB's contain additional relevant information for one or more of the entities extracted from the user's content.

More specifically, the Document Enhancer performs various types of semantic, contextual, linguistic, and image-based pattern matching to compare entities, topics, contexts, subjects, etc., of each expert KB to the information extracted from the arbitrary content being consumed or created by the user. In other words, the Document Enhancer uses a variety of techniques to determine various measures of similarity between each of the expert KB's and one or more of the entities extracted from the arbitrary content of the user to determine which of those KB's are relevant to the user content. Such techniques are well known to those skilled in the art and will not be described in detail herein.

Well known examples of similarity measures that can be adapted for use by the Document Enhancer for matching expert KB's to user content include, but are not limited to, the following:

Context similarity of user content to contextual vectors of candidate expert KB's and KB entries;

Lexical similarity between user content and a topic vocabulary of candidate expert KB's and KB entries;

Topic-identifier similarity between aggregated topic id models for the user content and topic id vectors of candidate expert KB's;

Topic vocabulary similarity between user content representations in a topic vocabulary space and topic vocabulary vectors of candidate expert KB's;

Number of different mentions in user content that can be disambiguated to the same candidate entity in an expert KB;

A determination of whether a particular context is found in the user content (such as the context “India” for the surface form “Ministry of Education” and the candidate disambiguation “Ministry of Education (India)”;

String similarity between a surface form of the user content and a canonical form of candidate KB entry;

Etc.

### 2.4 Authorization for use of Knowledge-Bases

As discussed above, the Document Enhancer evaluates entities extracted from the arbitrary content of the user to identify one or more expert KB's that are relevant to that content. Further, this identification of relevancy can be made based on the entire content, each paragraph of the content, each sentence, phrase or word of the content, image-based content, audio-based content, live or recorded speech-based content, etc.

Given the determination of relevancy of one or more expert KB's to the user content, the Document Enhancer first determines whether the user is authorized to use or access the recommended expert KB's, and then recommends one or more of those relevant expert KB's to the user in the event that the user access is not currently authorized. The Document Enhancer then provides an entity store or the like that allows the user to optionally select, subscribe, or otherwise obtain access or authorization to use one or more of the suggested or recommended expert KB's.

Access to any of the expert KB's via the entity store can be provided to users under any of a wide range of terms and conditions. For example, in the simplest case, access to particular KB's can be provided to users free of charge. Alternately, access to particular KB's can be provided to users on an ad-supported basis. For example, after the user watches or listens to one or more commercials or advertisements, the user will be granted one-time (or multiple time) access to one or more recommended KB's. Other access options include, but are not limited to pay-per-use options, pay for period of use options, pay for permanent use or license options, advertisement-based options, such as ad popups, ad banners, ad-based emails, etc.

In other words, after the Document Enhancer recommends particular expert KB's to the user, the Document Enhancer then provides access to an entity store or the like that allows the user to obtain access to one or more of the recommended expert KB's using a variety of access models, as discussed above.

### 2.5 Augmentation of User Content

As noted above, the Document Enhancer operates to augment arbitrary content being consumed, created, or otherwise accessed by the user so that the user can obtain additional information related to entities extracted from the user content, pursue related research, browse related content, view related images, listen to related audio, etc. Depending upon the data or information available in relevant expert KB's to which the user has access, augmentation may take any of a number of forms.

In particular, augmentation is based on the selected expert KB's and takes a variety of forms with respect to entities identified or extracted from the user content. These forms include, but are not limited to informational or image-based popups, hyperlinks to related data (e.g., turn a word or phrase in a document into a clickable link), related data displayed as overlays on the user content or in additional windows or tabs, etc. Further, the Document Enhancer can augment different parts of a document or other content using different expert KB's where the subject matter of the document or content changes between sections (e.g., sentences, paragraphs, textbook chapters, blogs having changing topics over some period of time, etc.).

Further, augmentation of user content may be performed in real-time. For example, assume that the user is typing a document in a word processor or text-based application and that the user types the term “challenger disaster.” In this example, the term “challenger disaster” will be highlighted or otherwise called out by the Document Enhancer, and one or more links or other material (e.g., images, audio news reports, etc.) will be provided relating to the explosion of the Challenger space shuttle in 1986.

In another example, assume that a family doctor begins typing patient symptoms into a patient history file or verbally dictating patient symptoms, etc. In this example, the Document Enhancer can present or recommend an evolving list of expert KB's that are potentially relevant to the patient symptoms to which the doctor can subscribe or otherwise access, or which are free to use, and thus, the patient can access when reading the doctor's message or email. Once access to those recommended expert KB's has been obtained, the Document Enhancer can augment the patient history, message or email with information extracted from the authorized expert KB's. Similar processes apply to any field of expertise, e.g., chemistry, car repairs, appliance services, astronomy, particular sports, particular hobbies, etc.

Note the in the example of a doctor preparing a message or email to the user, augmentations relative to the content being prepared by the doctor may or may not be explicitly included in the message to the user, even though that augmentation information is available for use by the doctor while the doctor is preparing the message or email, depending upon whether the user (or other third party) is authorized to access the corresponding expert KB. In fact, an instance of the Document Enhancer running on the user's computing device can reprocess the message or email receive from the doctor to enhance that message or email using one or more expert KB's that are accessible to the user. As such, it should be understood that augmentations for the same document may differ from user to user depending upon what expert KB's are accessible to the user that is generating or consuming that content.

In addition, entity extraction can be performed in real-time by using various speech recognition techniques, real-time analysis of typed material, etc. For example, assume that users are making claims or comments in a blog or comments section of a news article. Links or augmentation relating to those claims or comments (either in support of the claims or comments or refuting the claims or comments) can be provided in real-time by the Document Enhancer where the site hosting the blog or comments section of the news article has obtained access to the relevant KB's. As noted above, augmentations for the same document (e.g., blog, comments, or other content) may differ from user to user depending upon what expert KB's are accessible to particular users.

Another simple example, with respect to real-time evaluation of typed text, can be explained by a user typing the text fragment “. . . Sun revolves around the Earth . . . ” In this example, initial semantic evaluation and entity disambiguation by the Document Enhancer results in concepts or topics such as sun, earth, orbits, solar system, etc. These entities are in turn matched by the Document Enhancer to one or more expert KB's such as a KB based on solar system orbital mechanics. Augmentation of the text fragment “. . . Sun revolves around the Earth . . .” by the Document Enhancer then may then link to an image or text showing that the Earth revolves around the Sun, or to supporting links to the erroneous concept of “heliocentricism.” Note that the intent here is not to correct errors (e.g., the Sun clearly does not revolve around the Earth), although the augmentation information is clearly available for such purposes, but to link to relevant information that allows users to further explore the entity, concept, or topic being discussed.

In yet another example of real-time augmentation, assume that several users are sitting in their living room in front of computer or Xbox®, and talking about a particular topic such as, for example, football or spaceflight. An instantiation of the Document Enhancer running on such devices can recognize the speech of one or more of the users, extract corresponding entities, determine one or more relevant expert KB's, and then populate the screen with links, statistics, images, etc., that are relevant to the conversation without the user's needing to perform any explicit actions, except to obtain authorization for one or more relevant expert KB's in the event that those expert KB's have not already been authorized for use.

### 2.6 Exemplary System Architecture Options

In view of the preceding discussion, it should be clear that the Document Enhancer may be implemented using a variety of architectures, including, but not limited to combinations of both remote and local processing and augmentation of user content, remote processing and augmentation of user content, and local processing and augmentation of user content. One of the advantages of using at least partially remote processing architectures is that there may be many hundreds or many thousands of different expert KB's that make use of many petabytes or more of data storage. As such, it may not be feasible to download all potentially relevant KB's to the user's machine. However, given the rapidly increasing local memory and storage capabilities of local devices, and of cloud-based storage that emulates local storage, the user can run some or all of the operation of the Document Enhancer locally once one or more of the relevant expert KB's have been authorized. Note also that one or more of the expert KB's can be provided to the user in an encrypted format for local storage. Such locally stored encrypted expert KB's are then unlocked or decrypted once the use has obtained authorization or access to those expert KB's.

For example, in the case of combined local and remote processing, the Document Enhancer provides a local service or application that executes on the user's computing device to receive user content and perform a semantic analysis of that content to identify or extract entities, names, concepts, topics, etc. The Document Enhancer then sends that semantic information to a remote service component of the Document Enhancer executing on a remote server, on a cloud-based system, etc. This remote service component then evaluates the received semantic information, matches that information to one or more of the expert KB's, and returns a suggestion of one or more expert KB's to the user that are likely to be relevant to the semantic information identified in the user's content. If the user has not already obtained access rights to one or more of the recommended or suggested expert KB's, the Document Enhancer then allows the user to obtain access via some or all of the access models discussed above (e.g., subscription based access, pay-per-use, ad-supported access, free access, etc.). The Document Enhancer then proceeds to augment the user content based on some or all of the expert KB's for which the user has obtained access. Note that this augmentation can be performed either locally or remotely, with the results then being presented to the user in the form of augmented content.

In the case of remote processing, the Document Enhancer runs as a remote service that operates on a remote server, on a cloud-based system etc., to receive content from the user. This remote service then performs the semantic analysis of the received content to identify or extract entities, names, concepts, topics, etc. The remote service then evaluates the semantic information, matches that information to one or more of the expert KB's, and returns a suggestion of one or more expert KB's to the user that are likely to be relevant to the semantic information identified in the user's content. If the user has not already obtained access rights to one or more of the recommended or suggested expert KB's, the Document Enhancer then allows the user to obtain access via some or all of the access models discussed above (e.g., subscription based access, pay-per-use, ad-supported access, free access, etc.). The Document Enhancer then proceeds to augment the user content based on some or all of the expert KB's for which the user has obtained access. The augmented content is then returned to the user for local use.

Note that “users” should not be always considered as representing individuals. For example, a corporation having many employees or authorized users may license a particular database, or may have one or more proprietary expert KB's that are intended to be accessible to only those employees or authorized users. In this case, the licensed databases or proprietary expert KB's can be stored locally or provided via a remote or cloud-based component of the Document Enhancer to augment content of the employees or authorized users. For example, in a cloud-based scenario, an aerospace engineering corporation may provide one or more expert KB's tailored to that corporations internal proprietary engineering designs, financial statistics, marketing data, or other information, to a private or secure cloud-based component of the Document Enhancer. This proprietary information is then used by the Document Enhancer to automatically augment the content of groups of one or more employees or users that have been authorized by the corporation.

In the case of local processing, the Document Enhancer runs as a local service that operates on the user's computing device (that optionally makes use of private or protected cloud-based storage and/or processing). This local service performs semantic analysis of the user's content to identify or extract entities, names, concepts, topics, etc. The local service then evaluates the semantic information, matches that information to one or more of the expert KB's, and suggests one or more expert KB's to the user that are likely to be relevant to the semantic information identified in the user's content. If the user has not already obtained access rights to one or more of the recommended or suggested expert KB's, the Document Enhancer then allows the user to obtain access via some or all of the access models discussed above (e.g., subscription based access, pay-per-use, ad-supported access, free access, etc.). One or more of the expert KB's for which the user has obtained access can then be provided to the user for local or cloud-based storage and use. The Document Enhancer then locally augments the user content based on some or all of the expert KB's for which the user has obtained access.

### 3.0 Operational Summary of the Document Enhancer

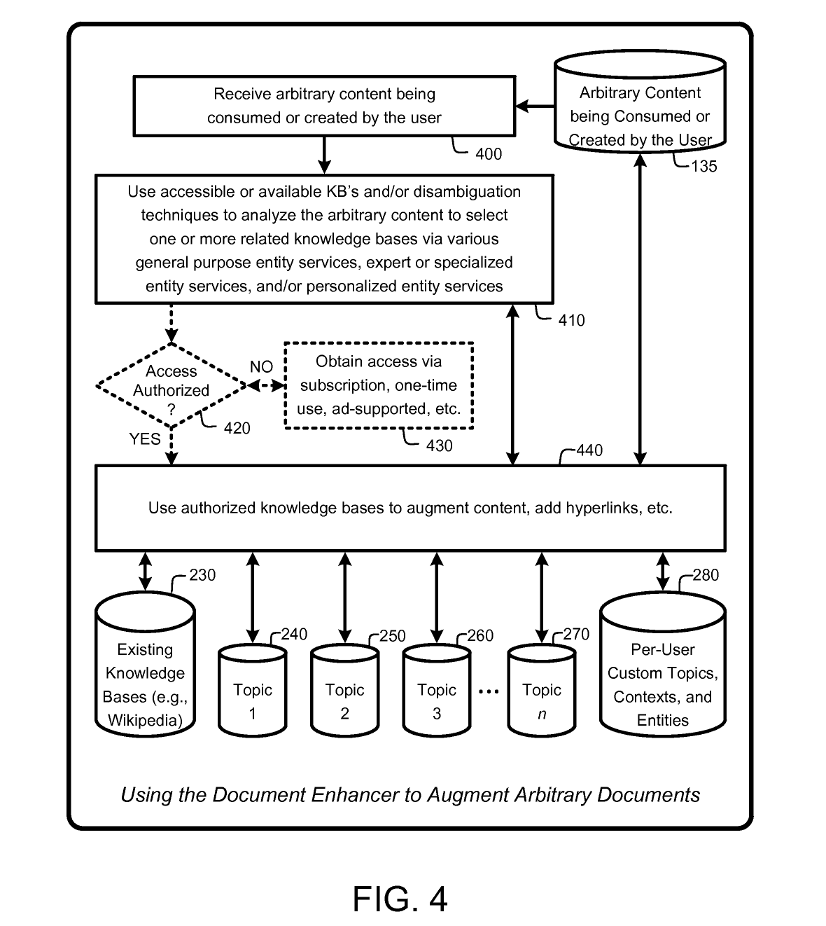

The processes described above with respect to FIG. 1 through FIG. 3, and in further view of the detailed description provided above in Sections 1 and 2, are illustrated by the general operational flow diagram of FIG. 4. In particular, FIG. 4 provides an exemplary operational flow diagram that summarizes the operation of some of the various embodiments of the Document Enhancer described above. Note that FIG. 4 is not intended to be an exhaustive representation of all of the various embodiments of the Document Enhancer described herein, and that the embodiments represented in FIG. 4 are provided only for purposes of explanation.

Further, it should be noted that any boxes and interconnections between boxes that are represented by broken or dashed lines in FIG. 4 represent optional or alternate embodiments of the Document Enhancer described herein, and that any or all of these optional or alternate embodiments, as described below, may be used in combination with other alternate embodiments that are described throughout this document.

In general, as illustrated by FIG. 4, the Document Enhancer begins operation by receiving 400 arbitrary content 135 being consumed by the user. The Document Enhancer then analyzes 410 that arbitrary content 135 to identify, recommend or select one or more related knowledge bases via various general-purpose entity services, expert or specialized entity services, and/or personalized entity services. Note that the identification and matching of related knowledge bases can be performed as a combined process.

If access to the identified, recommended, or selected KB's is not authorized 420, the Document Enhancer allows the user to obtain 430 access through an app store or the like using various means such as subscription-based access, one-time access, ad-supported access, etc. Once access has been authorized 420, the Document Enhancer uses the authorized KB's to augment the arbitrary content 135 being consumed or created by the user. As noted above, such augmentation includes, but is not limited to adding hyperlinks to entities within the arbitrary content, highlighting relevant entities in the arbitrary content, adding information or content from the expert KB's into (or adjacent to) the arbitrary content, enabling user searches based on the selected KB's, etc.

### 4.0 Exemplary Operating Environments

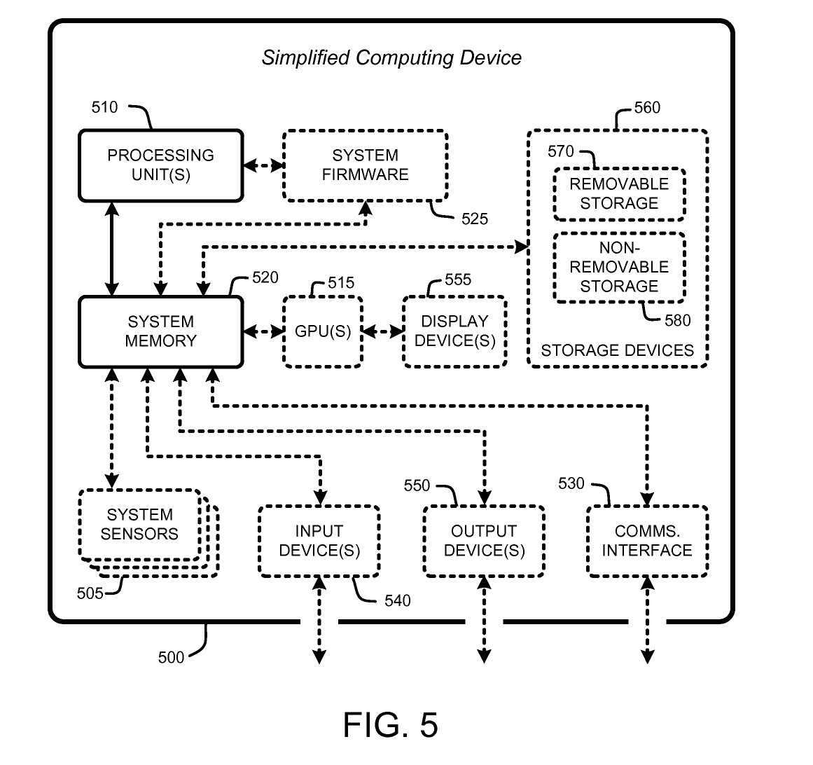

The Document Enhancer described herein is operational within numerous types of general purpose or special purpose computing system environments or configurations. FIG. 5 illustrates a simplified example of a general-purpose computer system on which various embodiments and elements of the Document Enhancer, as described herein, may be implemented. It should be noted that any boxes that are represented by broken or dashed lines in FIG. 5 represent alternate embodiments of the simplified computing device, and that any or all of these alternate embodiments, as described below, may be used in combination with other alternate embodiments that are described throughout this document.

For example, FIG. 5 shows a general system diagram showing a simplified computing device 500. Examples of such devices operable with the Document Enhancer, include, but are not limited to, portable electronic devices, wearable computing devices, hand-held computing devices, laptop or mobile computers, communications devices such as cell phones, smartphones and PDA's, multiprocessor systems, microprocessor-based systems, set top boxes, programmable consumer electronics, network PCs, minicomputers, audio or video media players, handheld remote control devices, etc. Note also that the Document Enhancer may be implemented with any touchscreen or touch-sensitive surface that is in communication with, or otherwise coupled to, a wide range of electronic devices or objects.

To allow a device to implement the Document Enhancer, the computing device 500 should have a sufficient computational capability and system memory to enable basic computational operations. In addition, the computing device 500 may include one or more sensors 505, including, but not limited to, accelerometers, cameras, capacitive sensors, proximity sensors, microphones, multi-spectral sensors, etc. Further, the computing device 500 may also include optional system firmware 525 (or other firmware or processor accessible memory or storage) for use in implementing various embodiments of the Document Enhancer.

As illustrated by FIG. 5, the computational capability of computing device 500 is generally illustrated by one or more processing unit(s) 510, and may also include one or more GPUs 515, either or both in communication with system memory 520. Note that that the processing unit(s) 510 of the computing device 500 may be a specialized microprocessor, such as a DSP, a VLIW, or other micro-controller, or can be a conventional CPU having one or more processing cores, including specialized GPU-based cores in a multi-core CPU.

In addition, the simplified computing device 500 may also include other components, such as, for example, a communications interface 530. The simplified computing device 500 may also include one or more conventional computer input devices 540 or combinations of such devices (e.g., touchscreens, touch-sensitive surfaces, pointing devices, keyboards, audio input devices, voice or speech-based input and control devices, video input devices, haptic input devices, devices for receiving wired or wireless data transmissions, etc.). The simplified computing device 500 may also include other optional components, such as, for example, one or more conventional computer output devices 550 (e.g., display device(s) 555, audio output devices, video output devices, devices for transmitting wired or wireless data transmissions, etc.). Note that typical communications interfaces 530, input devices 540, output devices 550, and storage devices 560 for general-purpose computers are well known to those skilled in the art, and will not be described in detail herein.

The simplified computing device 500 may also include a variety of computer readable media. Computer readable media can be any available media that can be accessed via storage devices 560 and includes both volatile and nonvolatile media that is either removable 570 and/or non-removable 580, for storage of information such as computer-readable or computer-executable instructions, data structures, program modules, or other data. By way of example, and not limitation, computer readable media may comprise computer storage media and communication media. Computer storage media refers to tangible computer or machine readable media or storage devices such as DVD's, CD's, floppy disks, tape drives, hard drives, optical drives, solid state memory devices, RAM, ROM, EEPROM, flash memory or other memory technology, magnetic cassettes, magnetic tapes, magnetic disk storage, or other magnetic storage devices, or any other device which can be used to store the desired information and which can be accessed by one or more computing devices.

Storage of information such as computer-readable or computer-executable instructions, data structures, program modules, etc., can also be accomplished by using any of a variety of the aforementioned communication media to encode one or more modulated data signals or carrier waves, or other transport mechanisms or communications protocols, and includes any wired or wireless information delivery mechanism. Note that the terms “modulated data signal” or “carrier wave” generally refer a signal that has one or more of its characteristics set or changed in such a manner as to encode information in the signal. For example, communication media includes wired media such as a wired network or direct-wired connection carrying one or more modulated data signals, and wireless media such as acoustic, RF, infrared, laser, and other wireless media for transmitting and/or receiving one or more modulated data signals or carrier waves. Combinations of the any of the above should also be included within the scope of communication media.

Retention of information such as computer-readable or computer-executable instructions, data structures, program modules, etc., can also be accomplished by using any of a variety of the aforementioned communication media to encode one or more modulated data signals or carrier waves, or other transport mechanisms or communications protocols, and includes any wired or wireless information delivery mechanism. Note that the terms “modulated data signal” or “carrier wave” generally refer to a signal that has one or more of its characteristics set or changed in such a manner as to encode information in the signal. For example, communication media includes wired media such as a wired network or direct-wired connection carrying one or more modulated data signals, and wireless media such as acoustic, RF, infrared, laser, and other wireless media for transmitting and/or receiving one or more modulated data signals or carrier waves. Combinations of the any of the above should also be included within the scope of communication media.

Further, software, programs, and/or computer program products embodying the some or all of the various embodiments of the Document Enhancer described herein, or portions thereof, may be stored, received, transmitted, or read from any desired combination of computer- or machine-readable media or storage devices and communication media in the form of computer executable instructions or other data structures.

Finally, the Document Enhancer described herein may be further described in the general context of computer-executable instructions, such as program modules, being executed by a computing device. Generally, program modules include routines, programs, objects, components, data structures, etc., that perform particular tasks or implement particular abstract data types. The embodiments described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

The foregoing description of the Document Enhancer has been presented for the purposes of illustration and description. It is not intended to be exhaustive or to limit the claimed subject matter to the precise form disclosed. Many modifications and variations are possible in light of the above teaching. Further, it should be noted that any or all of the aforementioned alternate embodiments may be used in any combination desired to form additional hybrid embodiments of the Document Enhancer. It is intended that the scope of the invention be limited not by this detailed description, but rather by the claims appended hereto. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented process for augmenting arbitrary user content, comprising:
using a computer to perform process actions for:
receiving arbitrary user content;
performing a first analysis of the arbitrary content to identify one or more entities in the arbitrary content;
matching the identified entities to one or more relevant expert knowledge bases;
providing the user with a plurality of access methods for authorizing use of one or more of the relevant expert knowledge bases; and
augmenting the arbitrary content relative to one or more of the identified entities using one or more of the authorized relevant expert knowledge bases.

2. The computer-implemented process of claim 1 further comprising process actions for performing a second analysis of the arbitrary content using one or more of the authorized relevant expert knowledge bases to identify one or more entities in the arbitrary content prior to augmenting the arbitrary content.

3. The computer-implemented process of claim 2 wherein the second analysis of the arbitrary content further comprises using any combination of the authorized relevant expert knowledge bases and relevant general knowledge bases to identify one or more entities in the arbitrary content.

4. The computer-implemented process of claim 1 wherein at least one access method is an advertisement-supported method wherein the user is granted authorization to use one or more of the expert knowledge bases after one or more advertisements have been presented to the user.

5. The computer-implemented process of claim 1 wherein at least one access method is a subscription-based method wherein the user is granted authorization to use one or more of the expert knowledge bases after obtaining a subscription to those expert knowledge bases.

6. The computer-implemented process of claim 1 wherein the arbitrary content includes user speech and further comprising process actions for recognizing the user speech and presenting augmented content relating to the user speech on a display device accessible to the user.

7. The computer-implemented process of claim 1 further comprising process actions for automatically ingesting one or more topical information sources and constructing one or more of the expert knowledge bases from the ingested topical information sources.

8. The computer-implemented process of claim 1 wherein augmenting the arbitrary content further comprises process actions for adding one or more relevant hyperlinks to one or more of the identified entities.

9. The computer-implemented process of claim 1 wherein augmenting the arbitrary content further comprises process actions for populating a user interface window with information relevant to one or more of the identified entities.

10. The computer-implemented process of claim 1 wherein augmenting the arbitrary content further comprises process actions for creating one or more informational overlays on the arbitrary content using information relevant to one or more of the identified entities.

11. A system for augmenting user content, comprising:
a general purpose computing device; and
a computer program comprising program modules executable by the computing device, wherein the computing device is directed by the program modules of the computer program to:
receive arbitrary user content;
extract a plurality of entities from the arbitrary content;
match the extracted entities to one or more relevant expert knowledge bases;
recommend one or more of the relevant expert knowledge bases to the user;
authorize the user to access to one or more of the relevant expert knowledge bases; and
augment the arbitrary content with information relevant to one or more of the extracted entities using one or more of the authorized expert knowledge bases.

12. The system of claim 11 wherein authorizing the user to access to one or more of the relevant expert knowledge bases further comprises a program module that enables the user to receive a paid subscription to one or more of the relevant expert knowledge bases.

13. The system of claim 11 wherein authorizing the user to access to one or more of the relevant expert knowledge bases further comprises a program module that enables the user to receive free access to one or more of the relevant expert knowledge bases after one or more advertisements have been presented to the user.

14. The system of claim 11 wherein the arbitrary content includes user speech, and further comprising a program module recognizing the user speech and presenting augmented content relating to the recognized user speech to the user.

15. The system of claim 11 wherein augmenting the arbitrary content further comprises adding one or more relevant hyperlinks to one or more of the extracted entities.

16. The system of claim 11 wherein augmenting the arbitrary content further comprises populating a user interface window with information relevant to one or more of the extracted entities.

17. A computer-readable medium having computer executable instructions stored therein for augmenting user content, said instructions causing a computing device to execute a method comprising:
receiving arbitrary user content;
extracting a plurality of entities from the arbitrary content;
matching the extracted entities to one or more relevant expert knowledge bases;
recommending one or more of the relevant expert knowledge bases to the user;
authorizing the user to access to one or more of the relevant expert knowledge bases; and
augmenting the arbitrary content with information relevant to one or more of the extracted entities using one or more of the authorized expert knowledge bases.

18. The computer-readable medium of claim 17 further comprising instructions for enabling the user to obtain a paid subscription to one or more of the relevant expert knowledge bases.

19. The computer-readable medium of claim 17 further comprising instructions for enabling the user to obtain free access to one or more of the relevant expert knowledge bases after one or more advertisements have been presented to the user.

20. The computer-readable medium of claim 17 wherein augmenting the arbitrary content further comprises process actions for creating one or more informational overlays on the arbitrary content using information relevant to one or more of the extracted entities.
